(19) United States
(12) Patent Application Publication
(10) Pub. No.: US 2022/0082061 A1
(43) Pub. Date: Mar. 17, 2022

(54) ENGINE BLOCK, RESIN BLOCK, AND METHOD OF MANUFACTURING ENGINE BLOCK

(71) Applicants: SUMITOMO BAKELITE CO., LTD., Tokyo (JP); NAGOYA ELECTRICAL EDUCATIONAL FOUNDATION, Nagoya-shi, Aichi (JP)

(72) Inventors: Shu Okasaka, Shinagawa-ku, Tokyo (JP); Toshio Fujimura, Toyota-shi, Aichi (JP)

(73) Assignees: SUMITOMO BAKELITE CO., LTD., Tokyo (JP); NAGOYA ELECTRICAL EDUCATIONAL FOUNDATION, Nagoya-shi, Aichi (JP)

(21) Appl. No.: 17/423,969

(22) PCT Filed: Jan. 8, 2020
(86) PCT No.: PCT/JP2020/000245

§ 371 Date: Jul. 19, 2021

(30) Foreign Application Priority Data
Jan. 17, 2019 (JP) 2019-005731
Jan. 17, 2019 (JP) 2019-005737

(51) Int. Cl. F02F 1/00; F02F 7/00; F02F 1/16

(52) U.S. Cl. CPC F02F 1/004; F02F 1/16; F02F 7/0085

(57) ABSTRACT

An engine block (10) includes a cylinder liner (120) and a resin block (200). The cylinder liner (120) has a metal outer circumferential surface (122). The resin block (200) includes a first portion (210) and a gap (230). The first portion (210) covers the metal outer circumferential surface (122) of the cylinder liner (120). The gap (230) is positioned outside the first portion (210) and defines a water jacket (232).

### TECHNICAL FIELD

The present invention relates to an engine block, a resin block, and a method of manufacturing an engine block.

### BACKGROUND ART

An internal combustion engine of an automobile has an engine block. The engine block includes a cylinder liner.

An example of an engine is disclosed in Non-Patent Document 1. The engine includes a cylinder liner and a resin that surrounds the cylinder liner. The cylinder liner is made of iron. Non-Patent Document 1 discloses that a cooling loss of the engine is reduced in a case in which the resin surrounds the cylinder liner as compared with a case in which aluminum surrounds the cylinder liner.

Patent Documents 1 and 2 disclose examples of an engine block. The engine block includes a cylinder liner and a block that surrounds the cylinder liner. The cylinder liner is made of a metal. The block is made of a resin. A water jacket is formed on the cylinder liner.

### RELATED DOCUMENT

### Patent Document

[Patent Document 1] US Patent Application Publication No. 2015/0159581
[Patent Document 2] US Patent Application Publication No. 2015/0159582

### Non-Patent Document

[Non-Patent Document 1] Takahiro Mizuno, Ryuki Tsuji, Toshio Fujimura “Fuel Efficiency Prediction of SI Engine with 1D Simulation” The Japan Society of Mechanical Engineers Tokai Branch 65th general assembly, The Proceedings of Conference (Mar. 17-18, 2016) No. 163-1

### SUMMARY OF THE INVENTION

### Technical Problem

(First Aspect)

As disclosed in Non-Patent Document 1, the cylinder liner may be surrounded with the resin in order to reduce the cooling loss. However, the present inventors have found that in a case in which the cylinder liner is surrounded with the resin, the resin can be damaged by heat generated from the cylinder liner.

An example of an object of the first aspect of the present invention is to reduce damage of the resin due to the heat generated from the cylinder liner. Another object of the first aspect of the present invention will be clarified from the description in the present specification.

(Second Aspect)

As disclosed in Non-Patent Document 1, the cylinder liner may be surrounded with the resin in order to reduce the cooling loss. The present inventors have studied to realize a manufacturing process for surrounding the cylinder liner with the resin at a low cost.

An example of an object of the second aspect of the present invention is to realize the manufacturing process for surrounding the cylinder liner with the resin at a low cost. Another object of the second aspect of the present invention will be clarified from the description in the present specification.

### Solution to Problem

An example of the first aspect of the present invention is an engine block including a cylinder liner having a metal outer circumferential surface, and a resin block, in which the resin block includes a first portion that covers the metal outer circumferential surface of the cylinder liner, and a gap that is positioned outside the first portion and defines a water jacket.

Another example of the first aspect of the present invention is a resin block including a first portion that covers a metal outer circumferential surface of a cylinder liner of an engine block, and a gap that is positioned outside the first portion and defines a water jacket.

Still another example of the first aspect of the present invention is a method of manufacturing an engine block, the method including a step of covering a metal outer circumferential surface of a cylinder liner with a first portion of a resin block, in which the resin block includes a gap that is positioned outside the first portion and defines a water jacket.

An example of the second aspect of the present invention is a method of manufacturing an engine block, the method including a step of forming a base block that has a cylinder liner having a metal outer circumferential surface, and a metal block surrounding the cylinder liner, a step of removing the metal block from the base block, and a step of surrounding the cylinder liner with a resin block after removing the metal block.

### Advantageous Effects of Invention

According to the first aspect of the present invention, the damage of the resin due to the heat generated from the cylinder liner can be reduced.

According to the second aspect of the present invention, the manufacturing process for surrounding the cylinder liner with the resin can be realized at a low cost.

### BRIEF DESCRIPTION OF THE DRAWINGS

The objects described above and other objects, features and advantages will be further clarified by the preferred embodiment described below and the accompanying drawings below.

FIG. 1 is an exploded view of an engine block and a cylinder head according to an embodiment.

FIG. 2 is a view for describing an example of a method of manufacturing the engine block shown in FIG. 1.

FIG. 3 is a view for describing an example of the method of manufacturing the engine block shown in FIG. 1.

FIG. 4 is a view for describing an example of the method of manufacturing the engine block shown in FIG. 1.

FIG. 5 is a view for describing an example of the method of manufacturing the engine block shown in FIG. 1.

FIG. 6 is a cross-sectional view for describing a detailed example of a cylinder liner.

### DESCRIPTION OF EMBODIMENTS

Hereinafter, an embodiment of the present invention will be described with reference to the drawings. In all drawings, similar components are designated by the same reference numerals, and description thereof will not be repeated.

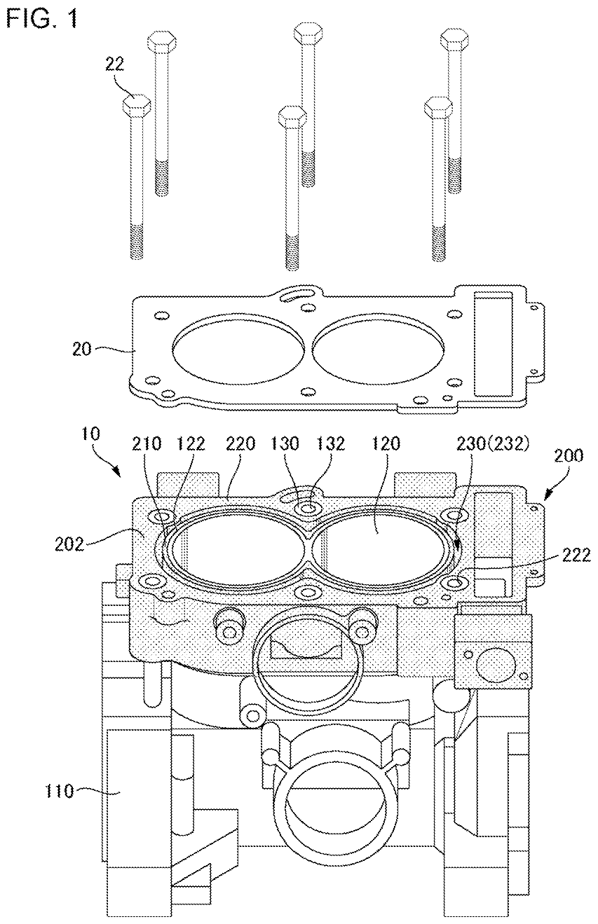

FIG. 1 is an exploded view of an engine block 10 and a cylinder head 20 according to an embodiment.

With reference to FIG. 1, an outline of the engine block 10 will be described. The engine block 10 includes a cylinder liner 120 and a resin block 200. The cylinder liner 120 has a metal outer circumferential surface 122. The resin block 200 includes a first portion 210 and a gap 230. The first portion 210 covers the metal outer circumferential surface 122 of the cylinder liner 120. The gap 230 is positioned outside the first portion 210 and defines a water jacket 232.

According to the configuration described above, the damage of the resin block 200 due to heat generated from the cylinder liner 120 can be reduced. Specifically, in the configuration described above, the first portion 210 of the resin block 200 is surrounded with the water jacket 232. Therefore, the thermal damage of the first portion 210 of the resin block 200 can be reduced by a refrigerant (for example, water) which flows through the water jacket 232.

With reference to FIG. 1, the details of the engine block 10 will be described.

The engine block 10 includes a block member 110, the cylinder liner 120, a protrusion 130, and the resin block 200.

The block member 110 is made of a metal (for example, cast iron, an aluminum alloy or a magnesium alloy). In the example shown in FIG. 1, the block member 110 functions as a base that supports the resin block 200.

The cylinder liner 120 is attached to the block member 110. The cylinder liner 120 may be integrated with the block member 110, or may be attachable to and detachable from the block member 110.

The cylinder liner 120 is made of a metal (for example, iron or aluminum). The cylinder liner 120 has an outer circumferential surface made of a metal (that is, the metal outer circumferential surface 122).

The protrusion 130 protrudes from the block member 110 toward the cylinder head 20 (that is, above the engine block 10). The protrusion 130 has an opening 132. A fixing tool 22 can be inserted into the opening 132. The fixing tool 22 fixes the cylinder head 20 to the engine block 10. As the fixing tool 22, for example, a bolt can be used.

The resin block 200 includes the first portion 210, a second portion 220, and the gap 230. The second portion 220 is positioned outside the gap 230. The gap 230 is positioned between the first portion 210 and the second portion 220. The first portion 210 and the second portion 220 are integrated with each other.

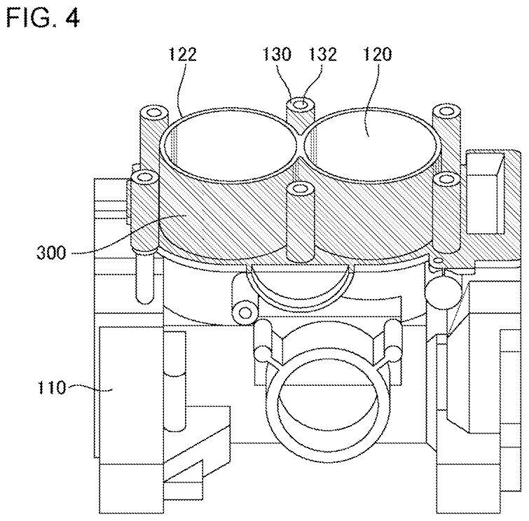

The first portion 210 of the resin block 200 may be attached to the metal outer circumferential surface 122 of the cylinder liner 120 through an adhesive (for example, an adhesive 300 which will be described below with reference to FIG. 4). The adhesive is positioned between the first portion 210 of the resin block 200 and the metal outer circumferential surface 122 of the cylinder liner 120, and bonds the first portion 210 of the resin block 200 and the metal outer circumferential surface 122 of the cylinder liner 120 to each other. The adhesive may function as a stress relaxing layer.

The first portion 210 of the resin block 200 may be integrally bonded to the metal outer circumferential surface 122 of the cylinder liner 120 without the adhesive (for example, the adhesive 300 which will be described below with reference to FIG. 4). In this case, a direct bond between the resin (resin block 200) and the metal (cylinder liner 120) is formed at an interface between the first portion 210 of the resin block 200 and the metal outer circumferential surface 122 of the cylinder liner 120.

The resin block 200 has an upper surface 202. The upper surface 202 has a groove that forms the gap 230 and is exposed from the block member 110. In such a structure, the thermal damage of the resin block 200 at an upper end of the cylinder liner 120 and the vicinity thereof can be particularly reduced. Therefore, the structure described above is particularly meaningful in a case in which the temperature of the cylinder liner 120 rises particularly at the upper end of the cylinder liner 120 and the vicinity thereof. Further, in the structure described above, the gap 230 can be formed after attaching the resin block 200 to the cylinder liner 120 as well as before attaching the resin block 200 to the cylinder liner 120. As a result, a degree of freedom of a process for forming the gap 230 can be increased.

The gap 230 may not be exposed from the upper surface 202 of the resin block 200, or may be present inside the resin block 200. Even in this case, the thermal damage of the first portion 210 of the resin block 200 can be reduced by the refrigerant which flows through the water jacket 232.

The second portion 220 has an opening 222. The resin block 200 is positioned such that the protrusion 130 penetrates the opening 222 of the second portion 220. The protrusion 130 can function as a guide that attaches the resin block 200 to the block member 110.

The first portion 210 and the second portion 220 of the resin block 200 contain a cured product of a thermosetting resin. Stated another way, the resin block 200 is made of the thermosetting resin. The resin block 200 may further contain an inorganic filler (for example, a glass fiber). The resin block 200 may contain, for example, 50% by weight or more of the inorganic filler with respect to a total weight of the resin block 200.

As the thermosetting resin that forms the resin block 200, for example, a phenol resin can be used.

A thermal conductivity of the thermosetting resin that forms the resin block 200 can be made low, for example, can be 1.00 W/m·K or less. The thermal conductivity is low, so that a cooling loss of the engine block 10 can be reduced.

A density of the thermosetting resin that forms the resin block 200 can be made small, for example, can be 2.2 g/cm³ or less. The density is small, so that a weight of the engine block 10 can be reduced.

A glass transition point of the thermosetting resin that forms the resin block 200 can be made high, for example, can be 160° C. or higher, and preferably 200° C. or higher. The glass transition point is high, so that the engine block 10 can be used at a high temperature.

A linear expansion coefficient of the thermosetting resin that forms the resin block 200 can be made equal to or approximate to a linear expansion coefficient of the metal that forms the metal outer circumferential surface 122 of the cylinder liner 120. For example, a machine direction (MD) linear expansion coefficient of the thermosetting resin that forms the resin block 200 may be 75% or more and 125% or less of a MD linear expansion coefficient of the metal that forms the cylinder liner 120, and a transverse direction (TD) linear expansion coefficient of the thermosetting resin that forms the resin block 200 may be 75% or more and 125% or less of a TD linear expansion coefficient of the metal that forms the cylinder liner 120. The linear expansion coefficient of the thermosetting resin that forms the resin block 200 and the linear expansion coefficient of the metal that forms the cylinder liner 120 are made equal to or approximate to each other, so that the stress from the cylinder liner 120 to the resin block 200 in a case in which both the cylinder liner 120 and the resin block 200 are heated can be relaxed.

Each of the MD linear expansion coefficient of the thermosetting resin that forms the resin block 200 and the MD linear expansion coefficient of the metal that forms the cylinder liner 120 can be, for example, 10 ppm or more and 40 ppm or less.

Each of the TD linear expansion coefficient of the thermosetting resin that forms the resin block 200 and the TD linear expansion coefficient of the metal that forms the cylinder liner 120 can be, for example, 10 ppm or more and 40 ppm or less.

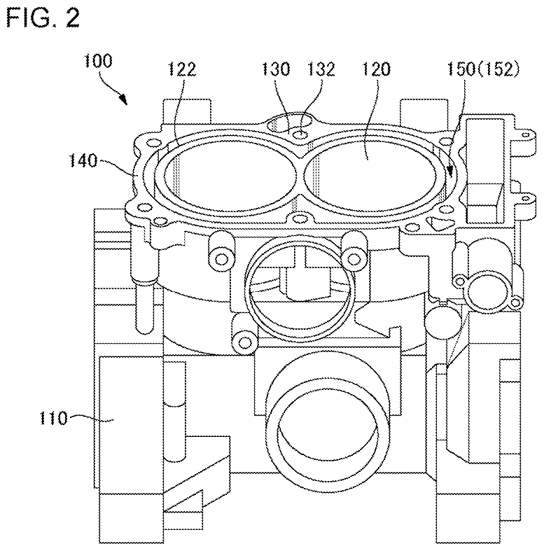

FIGS. 2 to 5 are views for describing examples of a method of manufacturing the engine block 10 shown in FIG. 1.

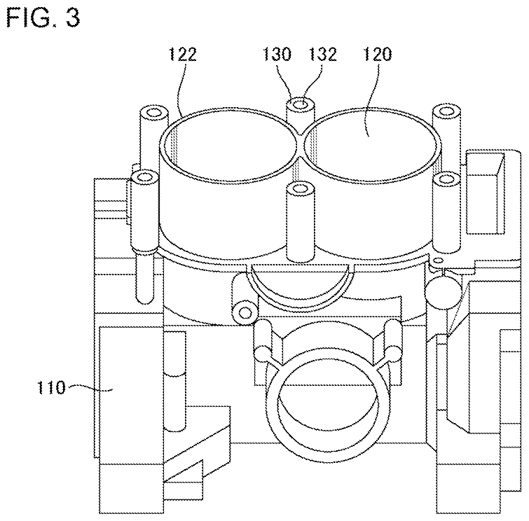

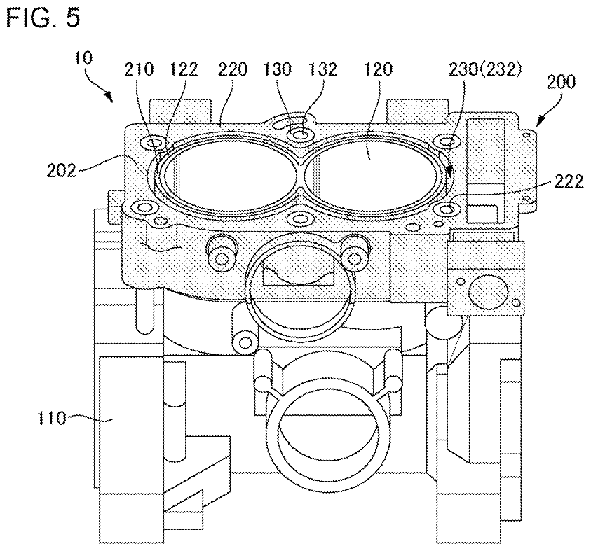

With reference to FIGS. 2, 3 and 5, an outline of the example of the method of manufacturing the engine block 10 will be described. First, a base block 100 is formed, as shown in FIG. 2. The base block 100 has the cylinder liner 120 and a metal block 140. The cylinder liner 120 has the metal outer circumferential surface 122. The metal block 140 surrounds the cylinder liner 120. Next, the metal block 140 is removed from the base block 100, as shown in FIG. 3. Then, the cylinder liner 120 is surrounded with the resin block 200, as shown in FIG. 5.

According to the process described above, a manufacturing process for surrounding the cylinder liner 120 with the resin block 200 can be realized at a low cost. Specifically, in the process described above, the base block 100 including the metal block 140 can be formed by using existing equipment for forming an existing engine block (for example, a mold used for casting to form an existing engine block). That is, it is not necessary to provide new equipment for forming the base block 100 from which the metal block 140 is removed. Therefore, the manufacturing process for surrounding the cylinder liner 120 with the resin block 200 can be realized at a low cost.

With reference to FIGS. 2 to 5, the details of the example of the method of manufacturing the engine block 10 will be described.

First, the base block 100 is formed, as shown in FIG. 2. The base block 100 has the block member 110, the cylinder liner 120, and the metal block 140. The block member 110, the cylinder liner 120, and the metal block 140 are each made of a metal. Particularly, the metal block 140 is made of, for example, cast iron, an aluminum alloy or a magnesium alloy.

The base block 100 has a gap 150 between the cylinder liner 120 and the metal block 140. The gap 150 defines a water jacket 152. The base block 100 can be formed by using existing equipment for forming an existing engine block (that is, the engine block having the water jacket 152). In the example, the base block 100 can be formed by casting, more specifically, die casting. In this example, as the mold used for die casting, the mold for forming the existing engine block can be used.

The base block 100 further has the opening 132. As described with reference to FIG. 1, the fixing tool 22 (FIG. 1) can be inserted into the opening 132. The base block 100 includes a portion that forms the protrusion 130 shown in FIG. 3. This portion forms the protrusion 130 in a step shown in FIG. 3 (step of removing the metal block 140).

Next, the metal block 140 is removed from the base block 100, as shown in FIG. 3. In the example shown in FIG. 3, the metal block 140 is removed such that the protrusion 130 is formed and the opening 132 remains.

Next, the adhesive 300 is formed on the metal outer circumferential surface 122 of the cylinder liner 120, as shown in FIG. 4. The adhesive 300 may also be formed on an outer circumferential surface of the protrusion 130, as shown in FIG. 4.

Then, the cylinder liner 120 is surrounded with the resin block 200, as shown in FIG. 5. The resin block 200 is attached such that the protrusion 130 penetrates the opening 222 of the resin block 200. The first portion 210 of the resin block 200 and the metal outer circumferential surface 122 of the cylinder liner 120 are bonded to each other through the adhesive 300 (FIG. 4), and an inner surface of the opening 222 of the resin block 200 and the outer circumferential surface of the protrusion 130 are bonded to each other through the adhesive 300 (FIG. 4).

The adhesive 300 (FIG. 4) may not be formed. In a case in which the adhesive 300 is not formed, the first portion 210 of the resin block 200 may be integrally bonded to the metal outer circumferential surface 122 of the cylinder liner 120 without the adhesive (for example, the adhesive 300 (FIG. 4)).

In the example shown in FIG. 5, the resin block 200 includes the first portion 210, the second portion 220, and the gap 230. The gap 230 defines the water jacket 232. The gap 230 may be formed before surrounding the cylinder liner 120 with the resin block 200, or may be formed after surrounding the cylinder liner 120 with the resin block 200.

The method of manufacturing the engine block 10 is not limited to the examples shown in FIGS. 2 to 5. The engine block 10 may be manufactured as in the following examples.

First, the blocks (block member 110, cylinder liner 120, and protrusion 130) shown in FIG. 3 may be formed without forming the base block 100 shown in FIG. 2. The blocks shown in FIG. 3 can be formed by casting, more specifically, die casting. In this example, the mold used for die casting has a shape along the blocks shown in FIG. 3.

Second, the engine block 10 may be manufactured by insert molding. In this example, the blocks (block member 110, cylinder liner 120, and protrusion 130) shown in FIG. 3 are disposed in the mold, and the resin that forms the resin block 200 is supplied into the mold. According to this example, the resin block 200 can be directly bonded to the cylinder liner 120 without the adhesive 300 shown in FIG. 4.

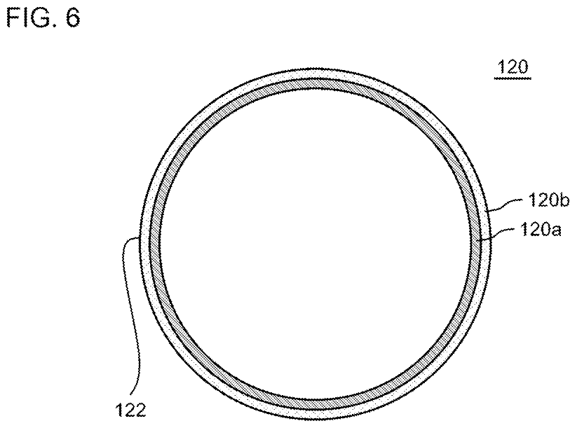

FIG. 6 is a cross-sectional view for describing a detailed example of the cylinder liner 120. FIG. 6 shows a cross section perpendicular to a height of the cylinder liner 120 (vertical direction in FIG. 1).

The cylinder liner 120 includes an iron layer 120a and an aluminum layer 120b. The iron layer 120a forms an inner circumferential surface of the cylinder liner 120. The iron layer 120a contains at least one of iron and ferroalloy. The aluminum layer 120b is positioned outside the iron layer 120a and forms the metal outer circumferential surface 122. The aluminum layer 120b contains at least one of aluminum and an aluminum alloy.

A surface roughness Ra (arithmetic average roughness) of the metal outer circumferential surface 122 of the cylinder liner 120 can be, for example, 0.2 μm or more and 3.0 μm or less.

The metal outer circumferential surface 122 of the cylinder liner 120 may not have a protruding portion having a point angle of less than 90°. Such a protruding portion can be a concentrated portion of the thermal stress of the cylinder liner 120 and the resin block 200, and can cause cracks in the resin block 200. In a case in which such a protruding portion is not provided, cracks in the resin block 200 can be reduced.

The embodiment of the present invention have been described above with reference to the drawings, but it is an example of the present invention, and various configurations other than the above can be adopted.

This application claims priority based on Japanese application Japanese Patent Application No. 2019-005731 filed on Jan. 17, 2019 and Japanese application Japanese Patent Application No. 2019-005737 filed on Jan. 17, 2019, all of its disclosures are incorporated herein.

1. An engine block comprising:
a cylinder liner having a metal outer circumferential surface; and
a resin block,
wherein the resin block includes a first portion that covers the metal outer circumferential surface of the cylinder liner, and a gap that is positioned outside the first portion and defines a water jacket.

2. The engine block according to claim 1,
wherein the resin block has an upper surface, and
the upper surface of the resin block has a groove that forms the gap.

3. The engine block according to claim 1, further comprising:
a protrusion having an opening into which a fixing tool to fix a cylinder head to the engine block is insertable,
wherein the resin block further includes a second portion that is positioned outside the gap and has an opening, and
the resin block is positioned such that the protrusion penetrates the opening of the second portion.

4. The engine block according to claim 1, further comprising:
an adhesive that is positioned between the first portion of the resin block and the metal outer circumferential surface of the cylinder liner.

5. The engine block according to claim 1,
wherein the first portion of the resin block is integrally bonded to the metal outer circumferential surface of the cylinder liner.

6. The engine block according to claim 1,
wherein a thermal conductivity of a thermosetting resin that forms the first portion of the resin block is 1.00 W/m·K or less.

7. The engine block according to claim 1,
wherein a machine direction (MD) linear expansion coefficient of a thermosetting resin that forms the first portion of the resin block is 75% or more and 125% or less of a MD linear expansion coefficient of a metal that forms the metal outer circumferential surface, and
a transverse direction (TD) linear expansion coefficient of the thermosetting resin that forms the first portion of the resin block is 75% or more and 125% or less of a TD linear expansion coefficient of the metal that forms the metal outer circumferential surface.

8. The engine block according to claim 1,
wherein a density of a thermosetting resin that forms the first portion of the resin block is 2.2 g/cm³ or less.

9. The engine block according to claim 1,
wherein a glass transition point of a thermosetting resin that forms the first portion of the resin block is 160° C. or higher.

10. The engine block according to claim 1,
wherein a thermosetting resin that forms the first portion of the resin block is a phenol resin.

11. The engine block according to claim 1,
wherein the resin block contains 50% by weight or more of an inorganic filler with respect to a total weight of the resin block.

12. The engine block according to claim 1,
wherein the cylinder liner includes an iron layer, and an aluminum layer that is positioned outside the iron layer and forms the metal outer circumferential surface.

13. The engine block according to claim 1,
wherein a surface roughness Ra of the metal outer circumferential surface of the cylinder liner is 0.2 μm or more and 3.0 μm or less.

14. The engine block according to claim 1,
wherein the metal outer circumferential surface of the cylinder liner does not have a protruding portion having a point angle of less than 90°.

15. A resin block comprising:
a first portion to cover a metal outer circumferential surface of a cylinder liner of an engine block; and
a gap that is positioned outside the first portion and defines a water jacket.

16. A method of manufacturing an engine block, the method comprising:
a step of covering a metal outer circumferential surface of a cylinder liner with a first portion of a resin block,
wherein the resin block includes a gap that is positioned outside the first portion and defines a water jacket.

17. (canceled)

18. (canceled)

19. (canceled)

20. (canceled)

21. (canceled)

22. (canceled)
